(19) United States
(12) Patent Application Publication
(10) Pub. No.: US 2017/0169463 A1
(43) Pub. Date: Jun. 15, 2017

(54) METHOD, APPARATUS, AND COMPUTER-READABLE MEDIUM FOR DETERMINING EFFECTIVENESS OF A TARGETING MODEL

(71) Applicant: Twenty-Ten, Inc., Toronto (CA)

(72) Inventors: Rob Couvillon, Toronto (CA); Jessica Velletri, Toronto (CA); Ian Alexander, Toronto (CA); Sheldon Smith, Toronto (CA); Brian Tranu, Brampton (CA)

(21) Appl. No.: 15/375,421

(22) Filed: Dec. 12, 2016

Related U.S. Application Data
(60) Provisional application No. 62/266,371, filed on Dec. 11, 2015.

(51) Int. Cl. G06Q 30/02

(52) U.S. Cl. CPC G06Q 30/0245; G06Q 30/0254; G06F 17/3053

(57) ABSTRACT

An apparatus, computer-readable medium, and computer-implemented method for determining effectiveness of a targeting model, including setting target variables corresponding to an initial group of consumers, the initial group of consumers corresponding to a subgroup of an experimental group of consumers which is larger than the initial group of consumers, applying the targeting model to an experimental set of consumer data corresponding to the experimental group of consumers to generate a plurality of experimental scores which score the experimental group of consumers according to projected fit with the target profile, identifying any experimental scores in the plurality of experimental scores which correspond to the initial group of consumers, and determining an effectiveness of the targeting model with respect to the target profile based at least in part on the target variables and one or more metrics which quantify the identified experimental scores relative to the plurality of experimental scores.

### RELATED APPLICATION DATA

This application claims priority to U.S. Provisional Application 62/266,371 filed Dec. 11, 2015, the disclosure of which is hereby incorporated by reference in its entirety.

### BACKGROUND

Consumer targeting models are used to target potential consumers in third-party or other databases for receipt of promotional materials, offers, and/or advertisements. However, targeting models are usually built using training data which may not accurately reflect how well the model will perform on non-training data.

Additionally, the effectiveness of a targeting model in identifying target consumers in non-training data can be difficult to ascertain, since the biographical, demographic, and other information necessary to determine whether a consumer is a target consumer is not always known for external data sets.

Accordingly, improvements are needed in systems for determining effectiveness of a targeting model.

### BRIEF DESCRIPTION OF THE DRAWINGS

FIG. 1 illustrates a flowchart for determining effectiveness of a targeting model according to an exemplary embodiment.

FIG. 2 illustrates a table showing consumers in an initial group of consumers, along with the target variable for each consumer, which indicates whether they are in a target group of consumers according to an exemplary embodiment.

FIG. 3 illustrates a table showing the results of applying a sample targeting model to an initial group of consumers according to an exemplary embodiment.

FIG. 4 illustrates a table showing the experimental scores for consumers in an experimental group of consumers according to an exemplary embodiment.

FIG. 5 illustrates a table showing the experimental scores for consumers which are also in an initial group of consumers according to an exemplary embodiment.

FIG. 6 illustrates a flowchart for determining an effectiveness of the targeting model with respect to the target profile based at least in part on the plurality of target variables and one or more metrics which quantify the identified experimental scores corresponding to the initial group of consumers relative to the plurality of experimental scores corresponding to the experimental group of consumers according to an exemplary embodiment.

FIG. 7 illustrates a table showing an example of the experimental ranking groups assigned to the consumers in the experimental group of consumers of FIG. 4 according to an exemplary embodiment.

FIG. 8 illustrates a flowchart for determining an effectiveness of the targeting model with respect to the target profile based at least in part on the plurality of target variables, a set of initial rank groups assigned to the initial group of consumers, and a set of experimental rank groups assigned to the initial group of consumers according to an exemplary embodiment.

FIGS. 9A-9D illustrate an example of the lift calculations described in FIG. 8 according to an exemplary embodiment.

FIG. 10 illustrates another flowchart for determining an effectiveness of the targeting model with respect to the target profile based at least in part on the plurality of target variables, a set of initial rank groups assigned to the initial group of consumers, and a set of experimental rank groups assigned to the initial group of consumers according to an exemplary embodiment.

FIGS. 11A-11C illustrate an example of the drift calculations described in FIG. 10 according to an exemplary embodiment.

FIG. 12 illustrates a flowchart for determining an effectiveness of the targeting model with respect to the target profile based at least in part on the plurality of target variables and one or more metrics which quantify the identified experimental scores corresponding to the initial group of consumers relative to the plurality of experimental scores corresponding to the experimental group of consumers according to an exemplary embodiment.

FIGS. 13A-13C illustrate an example of the method described in FIG. 12 according to an exemplary embodiment.

FIG. 14 illustrates an exemplary computing environment that can be used to carry out the method for determining effectiveness of a targeting model according to an exemplary embodiment.

### DETAILED DESCRIPTION

While methods, apparatuses, and computer-readable media are described herein by way of examples and embodiments, those skilled in the art recognize that methods, apparatuses, and computer-readable media for determining effectiveness of a targeting model are not limited to the embodiments or drawings described. It should be understood that the drawings and description are not intended to be limited to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include,” “including,” and “includes” mean including, but not limited to.

Applicant has discovered methods, apparatuses, and computer-readable media for determining effectiveness of a targeting model. The present system is able determine effectiveness of a targeting model on an experimental data set, such as a third-party database of consumer information, and accurately quantify metrics relating to the effectiveness of the targeting model in identifying consumers which match a target profile.

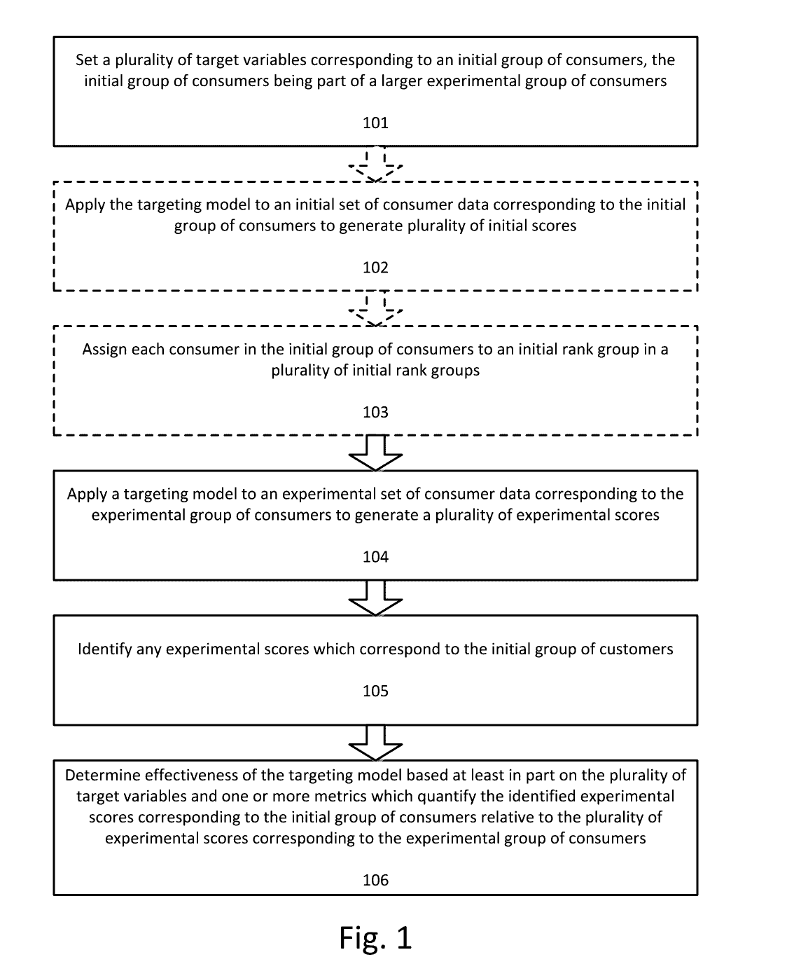

FIG. 1 illustrates a flowchart for determining effectiveness of a targeting model according to an exemplary embodiment. At step 101 a plurality of target variables corresponding to an initial group of consumers are set. As used herein, “consumers” means past consumers or customers, potential/future consumers or customers, or any other persons which can be targeted as consumers.

Each target variable in the plurality of target variables indicates whether a corresponding consumer in the initial group of consumers meets a target profile. For example, the target variable can indicate whether a particular consumer meets the requirements to be a target consumer for a particular company's marketing material. The target variable can also reflect some preference, characteristic, or demographic feature relating to the consumer, such as whether a respondent uses coupons, has a preference for laundry products with a strong scent, uses facial moisturizer at least once a day, etc.

Additionally, the initial group of consumers corresponds to a subgroup of an experimental group of consumers which is larger than the initial group of consumers. For example, given a particular third party database which will be used for a targeting model, a subset of the consumers in the third party database can be selected as the initial group of consumers and a target variable for each of the consumers can be set.

The target variable for each consumer in the initial group of consumer can be set in a variety of ways. For example, one or more survey questions can be transmitted to each consumer. The system can then receive one or more answers to the one or more survey questions, compare the one or more answers to one or more target answers specified in a target profile to a determine a matching percentage, and set a target variable corresponding to that consumer to true based at least in part on a determination that the matching percentage is above a predetermined threshold. The target profile can reflect characteristics, attributes, demographics, or behaviors that a particular marketer is seeking in a target consumer. The predetermined threshold can be customized for a particular marketer or company. For example, one marketer may be looking for target consumers that match every requirement in the target profile and therefore would utilized a predetermined threshold of 100% for survey answers, whereas another marketer may only require that nine out of ten requirements be fulfilled and therefore utilize a predetermined threshold of 90% for survey answers.

In addition to transmitting surveys and collecting answers, data used to set the target variables for consumers in the initial group can be collected in other ways, such as by scraping websites with information about the consumers, mining data relating to the consumers activities, downloading data from social media platforms, etc.

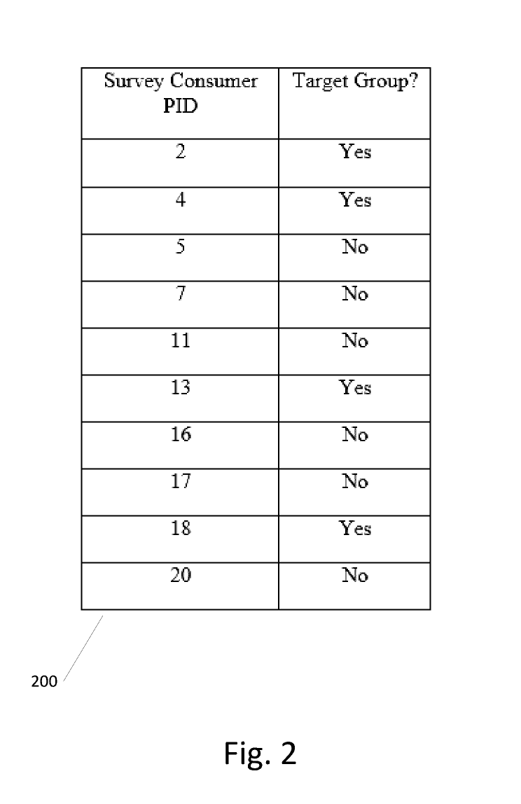

Additionally, any data relating to consumers in the initial group can be scrubbed for identifying or sensitive information so that each record for each consumer is anonymized. Each of the consumers can be identified using a Personal Identifier or “PID.” For example, FIG. 2 illustrates a table 200 showing 10 consumers in an initial group of consumers, along with the target variable for each consumer, which indicates whether they are in a target group of consumers.

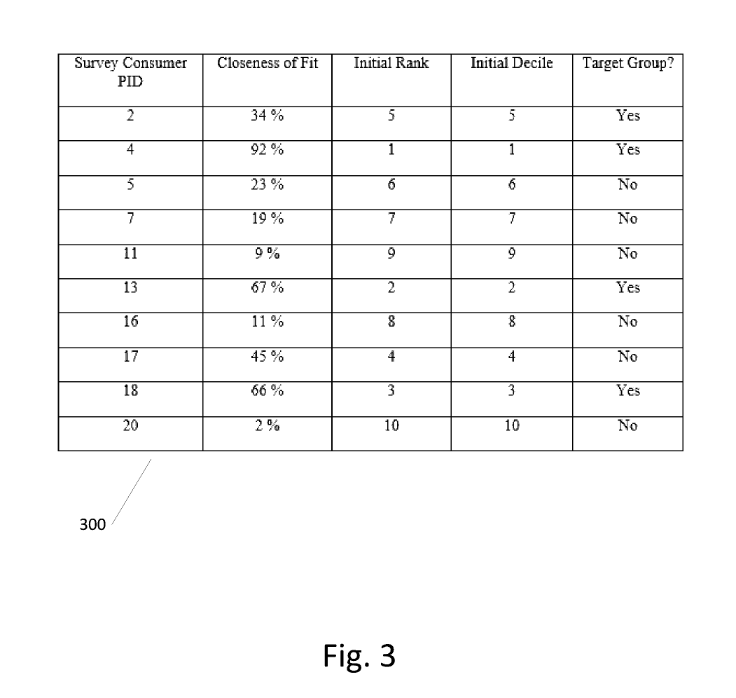

At optional step 102, a targeting model can be applied to an initial set of consumer data corresponding to the initial group of consumers to generate a plurality of initial scores which score the initial group of consumers according to projected fit with the target profile. FIG. 3 illustrates a table 300 showing the results of applying a sample targeting model to an initial group of consumers. Column “Closeness of Fit” in table 300 indicates the initial scores for the consumers which are based on the projected fit of each of the consumers with the target profile. The scores generated by the model can be based on a proximity or correlation between data values in the consumer data and data values which are either part of the target profile and/or data values which are correlated with the target profile. Additionally, the closeness of fit scores in the example tables are expressed as percentages for illustrative purposes only. A closeness of fit score can be any element of the Real number system.

Returning to FIG. 1, at optional step 103, each consumer in the initial group of consumers can be assigned to an initial rank group in a plurality of initial rank groups based at least in part on an initial score for that consumer relative to the plurality of initial scores. As shown in the initial rank column of table 300 in FIG. 3, each of the consumers are ranked according to their corresponding initial scores (closeness of fit scores). The consumers are also assigned to initial rank groups, referred to in table 300 as “deciles.” In the case of deciles, there are ten total rank groups and each consumer is assigned to a decile based on their initial score. However, the total number of rank groups utilized can be greater or less than 10 and each rank group can be referred to as an “N-tile.” For example, when the number of N-tiles is 10, then there are 10 rank groups, referred to as deciles. Similarly, when the number of N-tiles is 20, then there are 20 rank groups, referred to as ventiles. The N-tile size can be set by a user or determined based on characteristics of the consumer data set. For example, larger data sets can automatically be set to use larger number of N-tiles and smaller data sets can default to a smaller number of N-tiles.

Regardless of the number of N-tiles, the consumers in the initial group are assigned to an N-tile based on their initial ranks. For example, if there were 200 consumers and 10 N-tiles (deciles), then the top 20 ranking consumers (based on initial score) would assigned to the first N-tile (the first decile). If two consumers were to have the same initial score, then they would be assigned the same rank and would be assigned to the same N-tile. While the number of consumers assigned to each N-tile can be equal, this is not required.

As will be discussed further below, the initial rank groups generated from optional steps 102-103 in FIG. 1 can optionally be utilized to determine effectiveness of the targeting model.

Returning to FIG. 1, at step 104 the targeting model is applied to an experimental set of consumer data corresponding to the experimental group of consumers to generate a plurality of experimental scores which score the experimental group of consumers according to projected fit with the target profile. As discussed earlier, the experimental group of consumers will include the initial group of consumers, as well as one or more additional consumers which are not in the initial group of consumers. Additionally, the experimental set of consumer data can include the initial set of consumer data. The experimental group can also include consumers that correspond to the initial group of consumers but which are not the exact consumers in the initial group of consumers. For example, the experimental group can include a consumer that is in the same household or at the same address as a consumer in the initial group but that cannot be verified as the exact same consumer. In this case, the consumer in the experimental group can be considered to correspond to the consumer in the initial group.

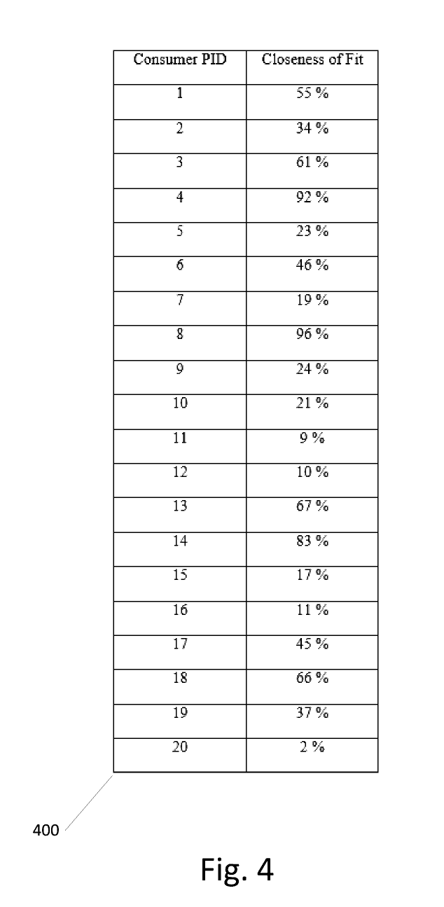

FIG. 4 illustrates a table 400 showing the experimental scores for consumers in an experimental group of consumers. The experimental scores are given by the “Closeness of Fit” column, which reflects the projected fit of a particular consumer with the target profile based on the consumer data for that consumer in the experimental set of consumer data.

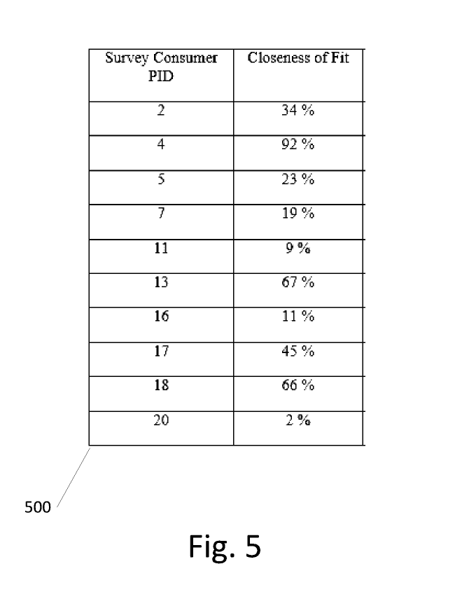

Returning to FIG. 1, at step 105 any experimental scores in the plurality of experimental scores which correspond to the initial group of consumers are identified. These experimental scores can then be flagged, extracted, or otherwise marked. FIG. 5 illustrates a table 500 showing the experimental scores for the consumers in table 400 of FIG. 4 which are also in the initial group of consumers shown in table 200 of FIG. 2. As shown in in FIG. 5 and FIG. 3, the experimental scores for each of the consumers in the initial group are the same as the initial scores for each of the consumers. As discussed above, the experimental scores which correspond to the initial group of consumers do not necessarily need to be scores which can be verified as corresponding to the exact consumers in the initial group. A consumer in the experimental group which has one or more identifying characteristics (address, last name, profile, etc.) which is the same as a consumer in the initial group can be considered to correspond to the consumer in the initial group, even if all of the biographical/demographic data is not an exact match.

At step 106 of FIG. 1 an effectiveness of the targeting model with respect to the target profile is determined based at least in part on the plurality of target variables and one or more metrics which quantify the identified experimental scores corresponding to the initial group of consumers relative to the plurality of experimental scores corresponding to the experimental group of consumers. As will be discussed below, the one or more metrics can include rankings and rank groups which rank and group each of the identified experimental scores relative to the plurality of experimental scores and/or score thresholds which are applied to identified experimental scores and which are based on mean and/or standard deviation values of the plurality of experimental scores.

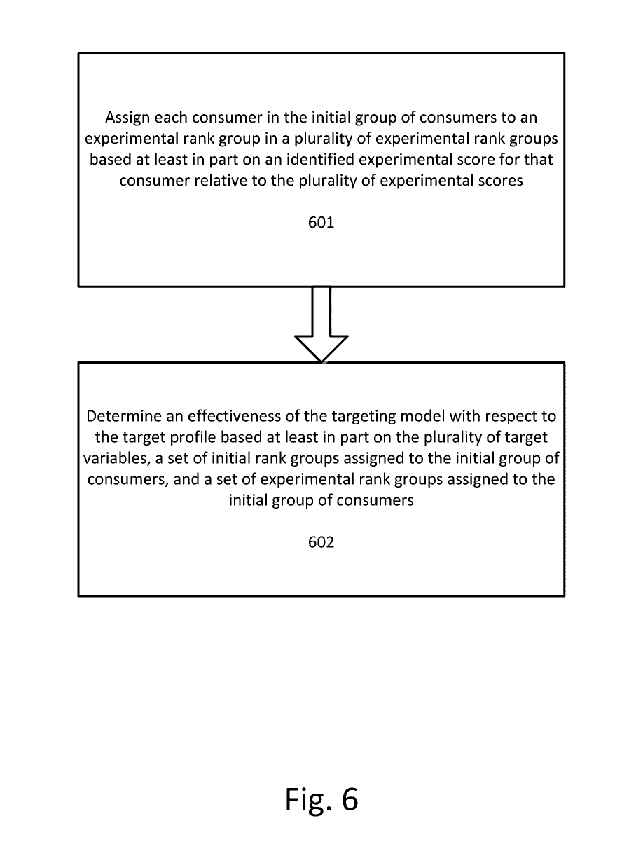

FIG. 6 illustrates a flowchart for determining an effectiveness of the targeting model with respect to the target profile based at least in part on the plurality of target variables and one or more metrics which quantify the identified experimental scores corresponding to the initial group of consumers relative to the plurality of experimental scores corresponding to the experimental group of consumers when optional steps 102-103 of FIG. 1 are performed.

As discussed earlier, optional steps 102-103 of FIG. 1 result in each consumer in the initial group of consumers being assigned to an initial rank group. At step 601 of FIG. 6, each consumer in the initial group of consumers is assigned to an experimental rank group in a plurality of experimental rank groups based at least in part on an identified experimental score for that consumer relative to the plurality of experimental scores. The experimental rank groups are also divided in to N-tiles, as discussed above with respect to initial rank groups. Additionally, the quantity of experimental rank groups is set to be equal to a quantity of initial rank groups and each experimental rank group in the plurality of experimental rank groups corresponds to an initial rank group in the plurality of initial rank groups. For example, when there are 10 N-tiles, then each decile for the initial rank groups corresponds to a decile for the experimental rank groups (1^{st} decile initial→1^{st} decile experimental, 2^{nd} decile initial→2^{nd} decile experimental, etc.).

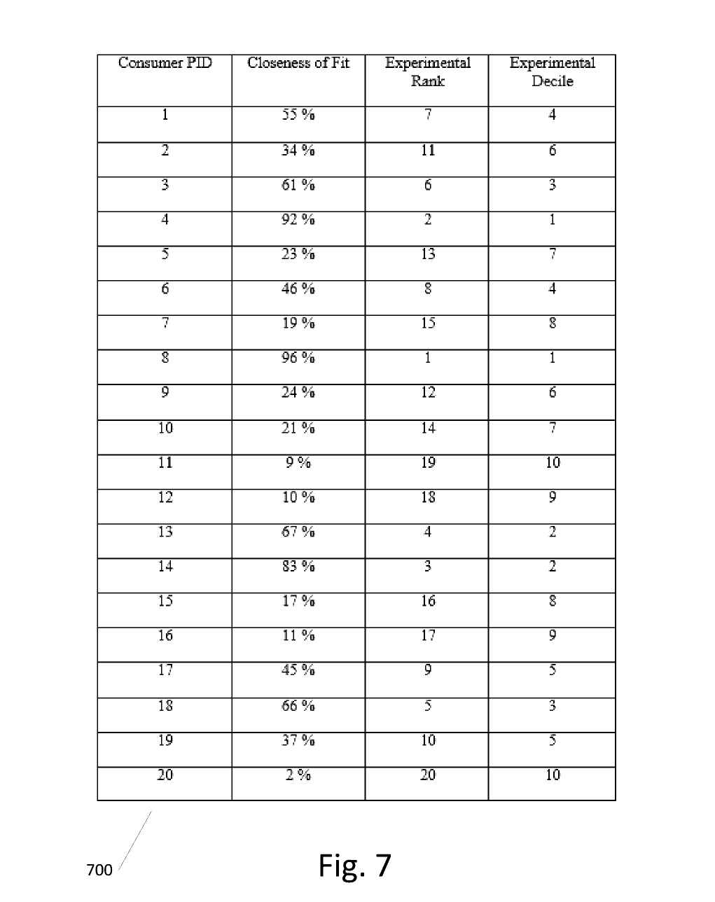

FIG. 7 illustrates a table 700 showing an example of the experimental ranking groups assigned to the consumers in the experimental group of consumers of FIG. 4 according to an exemplary embodiment. The experimental rank groups are based on experimental ranks assigned to each of the consumers and the experimental ranks, in turn, are based on the experimental scores (Closeness of Fit) assigned to each consumer in the experimental group of consumers. As shown in FIG. 7, the experimental rank groups are indicated as experimental deciles, which correspond to the initial deciles which were used as initial rank groups.

Returning to FIG. 6, at step 602 an effectiveness of the targeting model with respect to the target profile is determined based at least in part on the plurality of target variables, a set of initial rank groups assigned to the initial group of consumers, and a set of experimental rank groups assigned to the initial group of consumers.

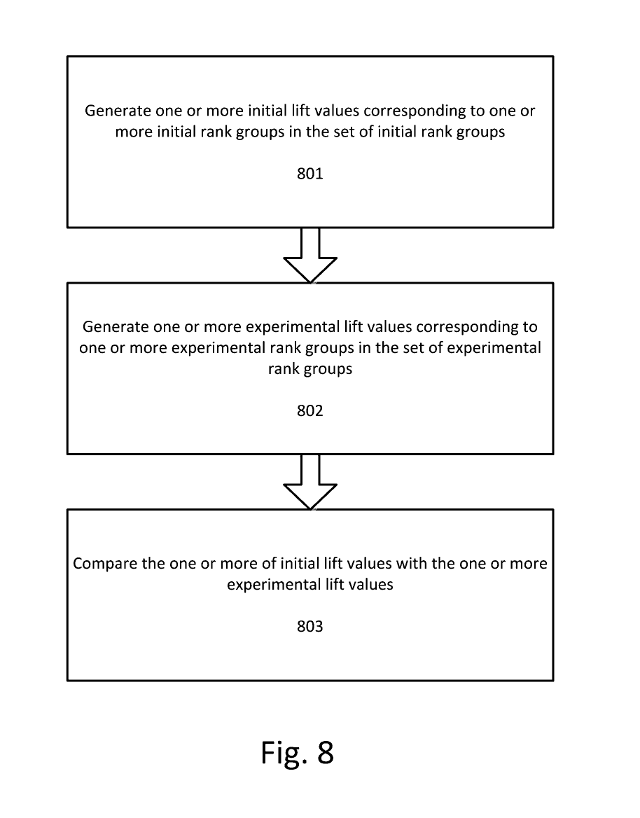

FIG. 8 illustrates a flowchart for determining an effectiveness of the targeting model with respect to the target profile based at least in part on the plurality of target variables, a set of initial rank groups assigned to the initial group of consumers, and a set of experimental rank groups assigned to the initial group of consumers according to an exemplary embodiment.

At step 801 one or more initial lift values are generated corresponding to one or more initial rank groups in the set of initial rank groups by calculating an initial percentage of consumers in each initial rank group in the one or more initial rank groups which have a corresponding target variable that indicates that the consumer meets the target profile and dividing the initial percentage by a percentage of consumers in the initial group of consumers which have a corresponding target variable that indicates that the consumer meets the target profile. Lift can be defined as the percentage change (increase/decrease) of identification of a target consumer in a particular N-tile relative to the overall incidence of target consumers in the data set (the initial group of consumers in this case—since the value of the target variable is known only for the initial group of consumers in our data set).

At step 802 one or more experimental lift values corresponding to one or more experimental rank groups in the set of experimental rank groups are generated by calculating an experimental percentage of consumers in each experimental rank group in the one or more experimental rank groups which have a corresponding target variable that indicates that the consumer meets the target profile and dividing the experimental percentage by the percentage of consumers in the initial group of consumers which have a corresponding target variable that indicates that the consumer meets the target profile.

Additionally, at step 803 the one or more initial lift values are compared with the one or more experimental lift values to determine whether the model is as effective on the experimental set of consumer data as it is on the initial set of consumer data.

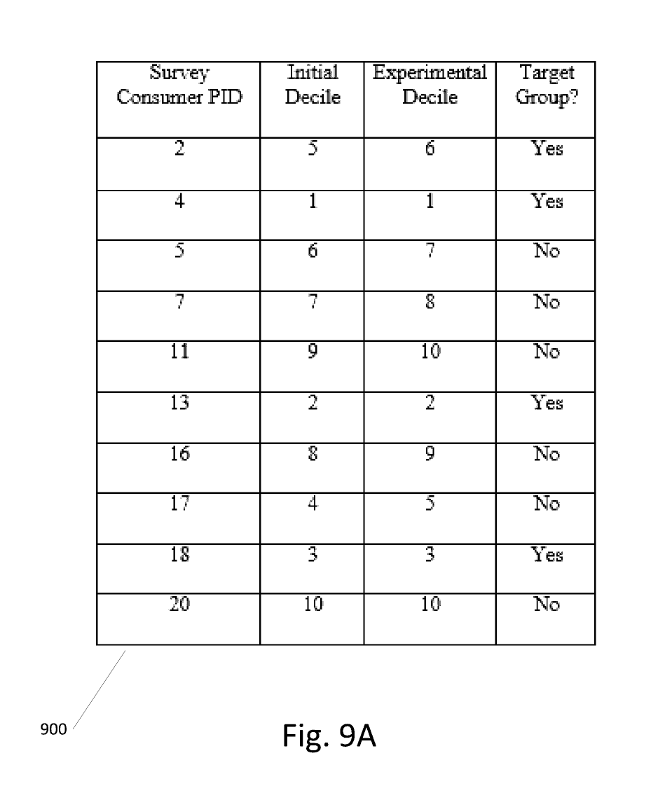

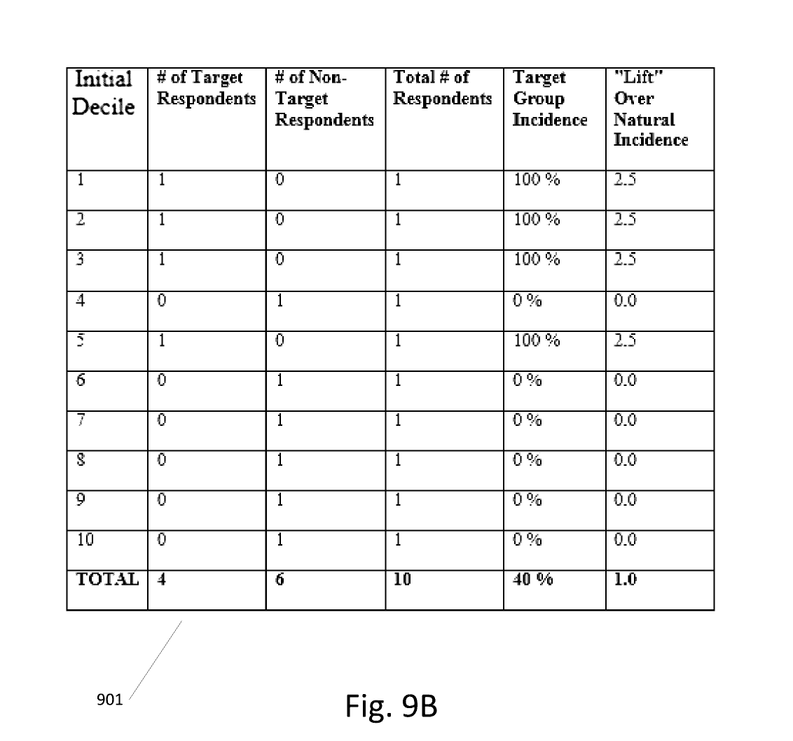

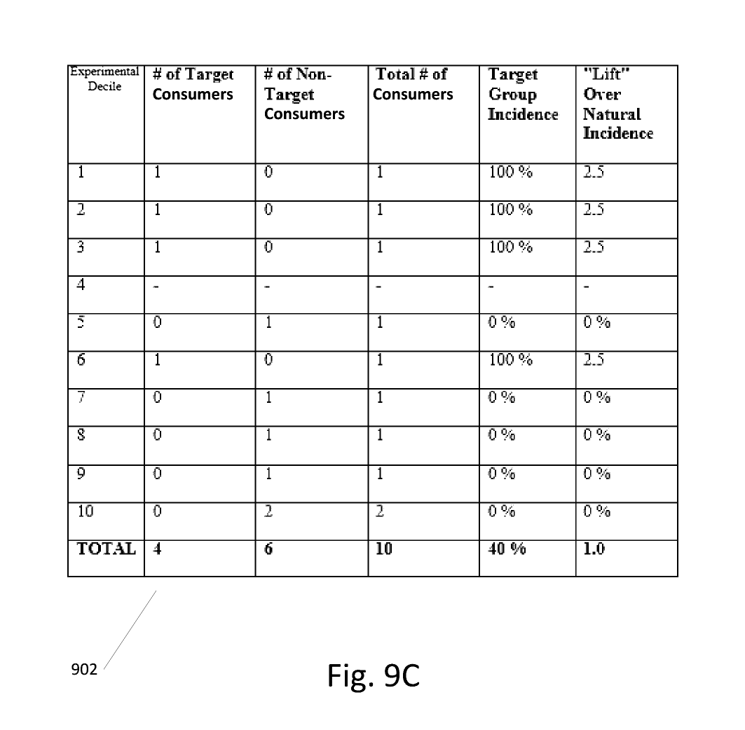

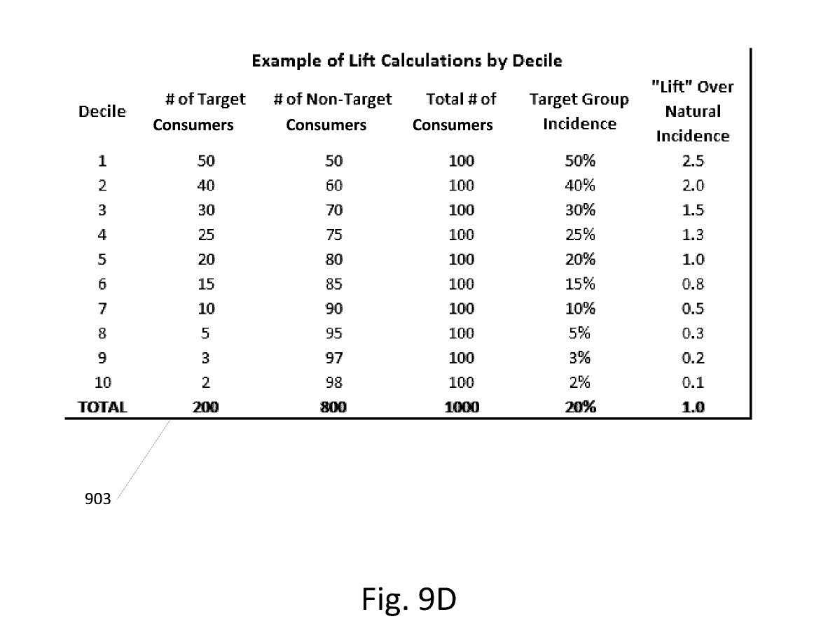

FIGS. 9A-9D illustrate an example of the lift calculations described in FIG. 8. As shown in table 900 of FIG. 9A, each consumer in the initial group of consumers has been assigned an initial rank group (initial decile) and an experimental rank group (experimental decile). Also indicated in table 900 is the value of the target variable for each consumer (whether the consumer is in the target group).

FIG. 9B illustrates a table 901 showing the initial percentage of consumers in each initial rank group (initial decile) in the set of initial rank groups which have a corresponding target variable that indicates that the consumer meets the target profile. This percentage is listed as the target group incidence for each rank group. Table 901 also shows the lift within each initial decile over the natural incidence. The natural incidence is the total percentage of consumers in the initial group of consumers which have a corresponding target variable that indicates that the consumer meets the target profile. In this case, the natural incidence is 40%, since 4 out of 10 total consumers are in the target group. So, for example, the lift for initial decile 2 is the target group incidence for that initial decile (100%) divided by the natural incidence (40%), which results in a life of 2.5.

FIG. 9C illustrates a table 902 showing the experimental percentage of consumers in each experimental rank group (experimental decile) in the set of experimental rank groups which have a corresponding target variable that indicates that the consumer meets the target profile. This percentage is listed as the target group incidence for each rank group. Table 902 also shows the lift within each experimental decile over the natural incidence. The natural incidence is the total percentage of consumers in the initial group of consumers which have a corresponding target variable that indicates that the consumer meets the target profile. In this case, the natural incidence is 40%, since 4 out of 10 total consumers (in the initial group) are in the target group. So, for example, the lift for experimental decile 6 is the target group incidence for that experimental decile (100%) divided by the natural incidence (40%), which results in a life of 2.5.

FIGS. 9B-9C deliberately use a small sample size to illustrate the lift calculations that are performed. However, in practice, the sample sizes would usually be much larger. For example, FIG. 9D illustrates a table 903 showing lift calculations that can be performed for a much larger data set.

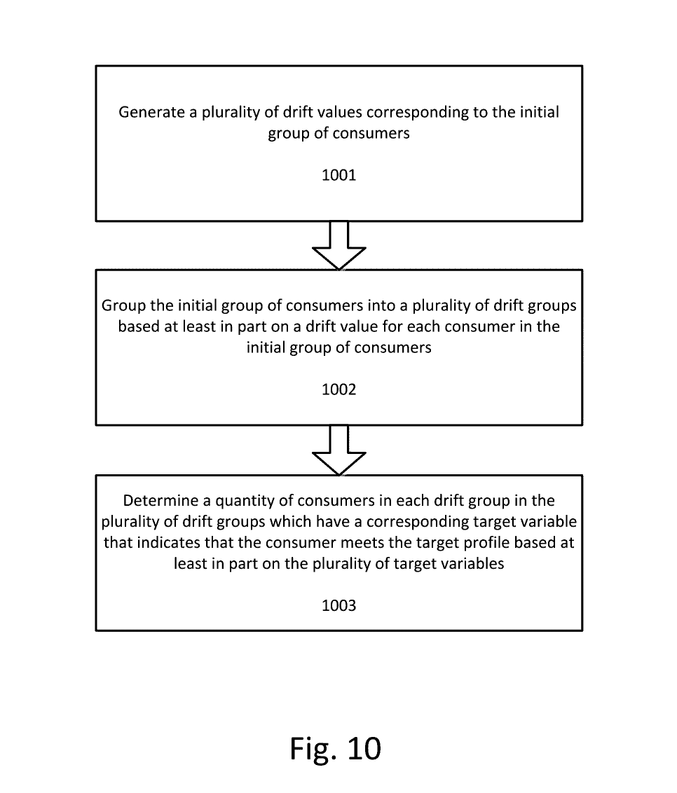

In addition to lift, there are other metrics which can be calculated to determine effectiveness of the targeting model. FIG. 10 illustrates another flowchart for determining an effectiveness of the targeting model with respect to the target profile based at least in part on the plurality of target variables, a set of initial rank groups assigned to the initial group of consumers, and a set of experimental rank groups assigned to the initial group of consumers according to an exemplary embodiment.

At step 1001 a plurality of drift values corresponding to the initial group of consumers are generated by comparing, for each consumer in the initial group of consumers, an initial rank group assigned to that consumer and an experimental rank group assigned to that consumer. The drift can be given by the initial rank group—experimental rank group.

At step 1002 the initial group of consumers are grouped into a plurality of drift groups based at least in part on a drift value for each consumer in the initial group of consumers.

Additionally, at step 1003 a quantity of consumers in each drift group which have a corresponding target variable that indicates that the consumer meets the target profile based at least in part on the plurality of target variables is determined.

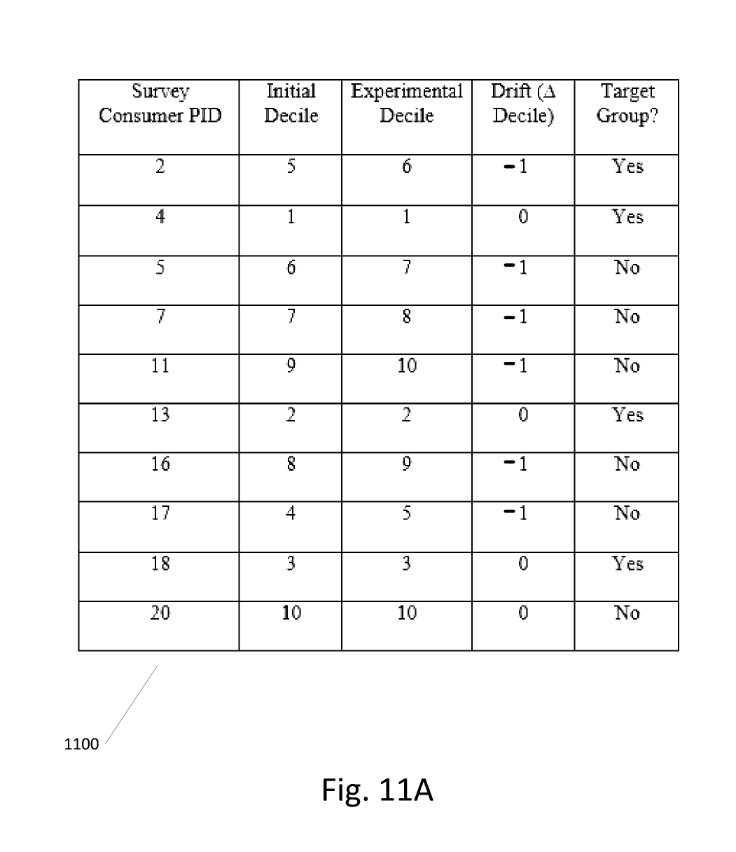

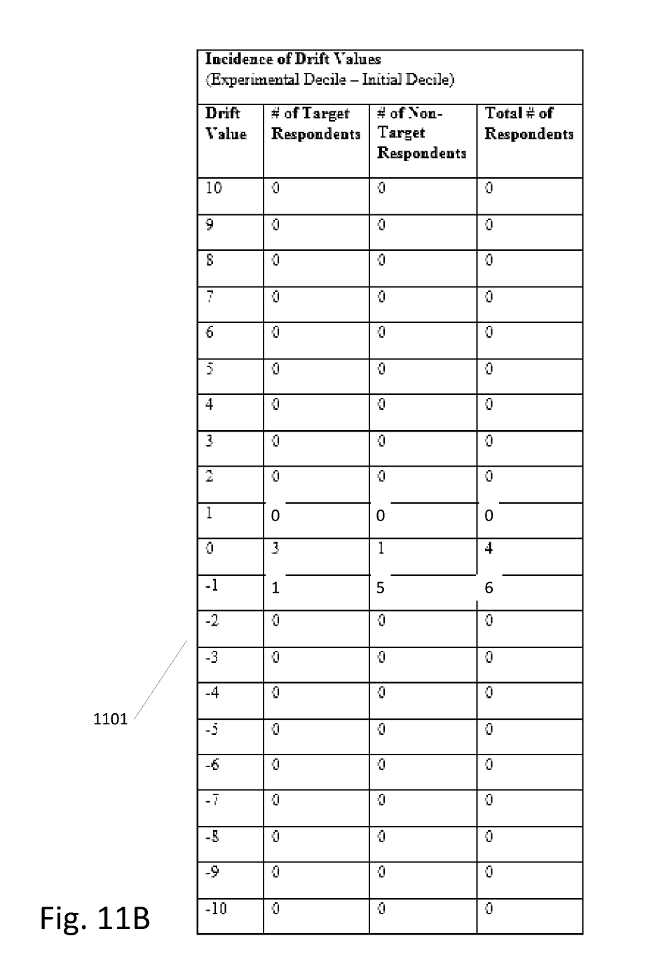

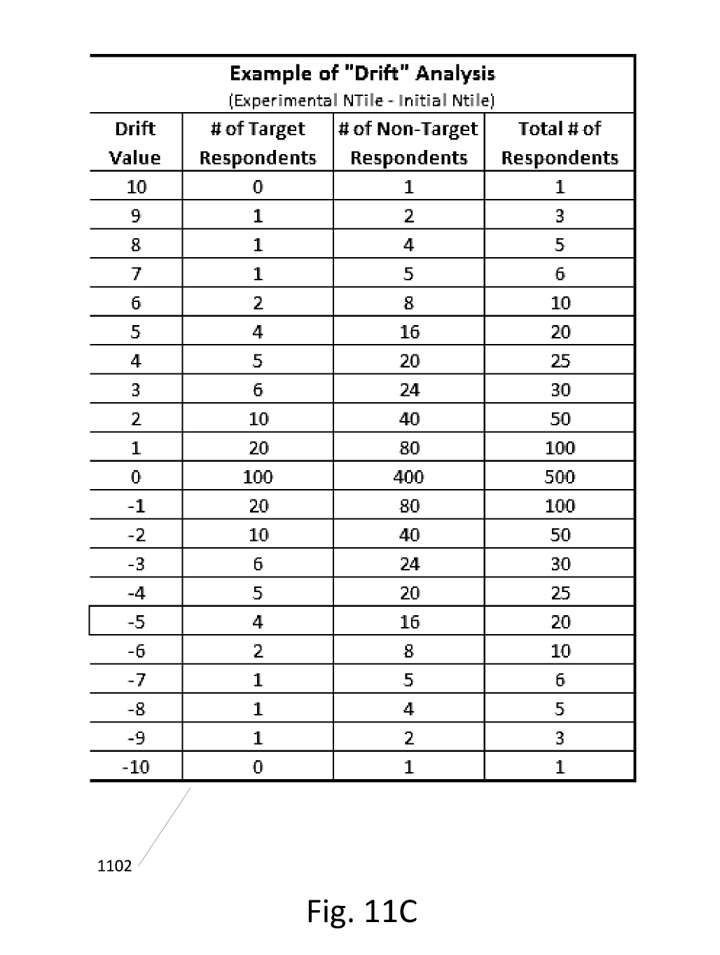

FIGS. 11A-11C illustrate an example of the drift calculations described in FIG. 10. FIG. 11A illustrates a table 1100 which includes a drift value for each consumer in the initial group of consumers. As discussed earlier, the drift can be given by the initial rank group (initial decile/N-Tile)—experimental rank group (experimental decile/N-Tile). A negative drift indicates that the model scored the initial consumers in the experimental data set lower than the initial consumers in the initial data set.

FIG. 11B illustrates a table 1101 showing the incidence of drift values when the initial group of consumers are grouped into drift groups corresponding to their respective drift values. Table 1101 also illustrates the number of target (having a target variable=true or yes) and non-target (having a target variable=false or no) consumers in each drift group. As discussed with respect to step 1003 of FIG. 10, this can be determined based on the values of the target variables for each of the consumers in the initial group of consumers.

FIG. 11B deliberately uses a small sample size to illustrate the drift calculations that are performed. However, in practice, the sample sizes would usually be much larger. For example, FIG. 11C illustrates a table 1102 showing drift calculations that can be performed for a much larger data set.

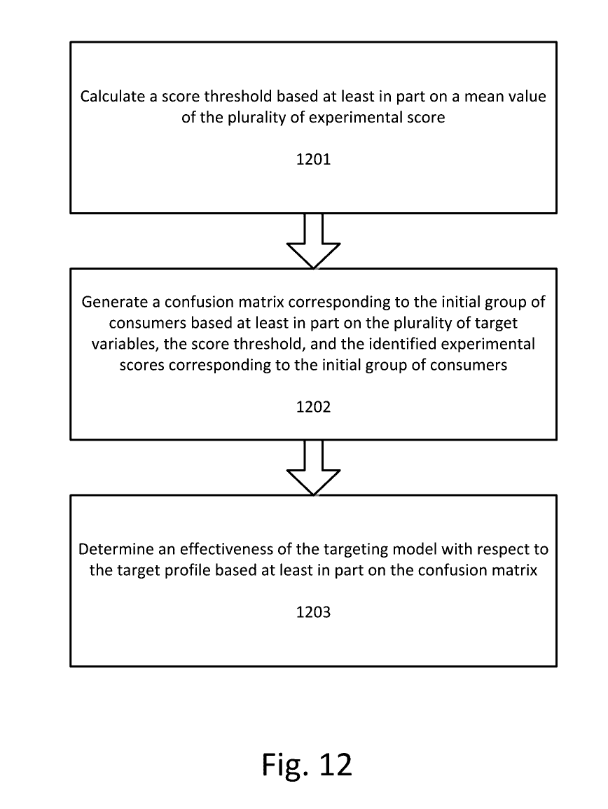

As shown in FIG. 1, steps 102-103 are optional and the effectiveness of the targeting model can be determined even when they are not performed. FIG. 12 illustrates a flowchart for determining an effectiveness of the targeting model with respect to the target profile based at least in part on the plurality of target variables and one or more metrics which quantify the identified experimental scores corresponding to the initial group of consumers relative to the plurality of experimental scores corresponding to the experimental group of consumers. The steps shown in FIG. 12 can be performed even when optional steps 102-103 of FIG. 1 are not performed.

At step 1201 a score threshold is calculated based at least in part on a mean value of the plurality of experimental scores. The score threshold can be a variable threshold dependent on a variable ν, such that:

the score threshold=μ+(ν*σ)

where μ comprises the mean value of the plurality of experimental scores,

where σ comprises a standard deviation of the plurality of experimental scores, and

where ν comprises a variable value greater than or equal to zero.

As discussed below, the score threshold is a value that can be used to determine whether a particular consumer in the initial group of consumers was forecast by the model to be a target consumer or forecast by the model to not be a target consumer. For example, if an experimental score corresponding to a particular consumer is above the score threshold, then that consumer can be considered to be forecast as a target consumer for that value of the score threshold. As the value of ν increases, the score threshold increases correspondingly, requiring a higher experimental score in order for a consumer to be considered to be forecast by the model as a target consumer. The value of ν can be set by a user or can be automatically determined based on the size of the data set or requirements pertaining to the effectiveness of the targeting model. For example, if the targeting model is required to be highly accurate, then the ν variable would be set to a higher value than if the targeting model is required to only be marginally accurate.

At step 1202 a confusion matrix corresponding to the initial group of consumers is generated based at least in part on the plurality of target variables, the score threshold, and the identified experimental scores corresponding to the initial group of consumers. The confusion matrix can store a designation for each consumer in the initial group of consumers based on the target variable corresponding to that consumer (whether the consumer meets the target profile), the score threshold, and the identified experimental score for that consumer.

The step of generating a confusion matrix can include assigning designations as follows:

A designation of true positive (TP) to each consumer in the initial group of consumers having an identified experimental score above the score threshold and having a corresponding target variable that indicates that the consumer meets the target profile;

A designation of false positive (FP) to each consumer in the initial group of consumers having an identified experimental score above the score threshold and having a corresponding target variable that indicates that the consumer does not meet the target profile;

A designation of true negative (TN) to each consumer in the initial group of consumers having an identified experimental score below or equal to the score threshold and having a corresponding target variable that indicates that the consumer does not meet the target profile; and

A designation of false negative (FN) to each consumer in the initial group of consumers having an identified experimental score below or equal to the score threshold and having a corresponding target variable that indicates that the consumer meets the target profile.

Additionally, the step of generating a confusion matrix can include calculating a total number of true positives, a total number of false positives, a total number of true negatives, and a total number of false negatives. These total numbers can then be stored, along with the determined designations for each consumer in the initial set of consumers, in the confusion matrix.

At step 1203 an effectiveness of the targeting model with respect to the target profile can be determined based at least in part on the confusion matrix or a portion of the confusion matrix. The effectiveness of the targeting model can be measured with respect to one or more of the following metrics:

an accuracy of the targeting model, where:

$$accuracy = \frac{\begin{matrix}the total number of true positives + \\ the total number of true negatives\end{matrix}}{total number of initial consumers} ;$$

a natural incidence of the targeting model, where:

$$natural incidence = \frac{\begin{matrix}the total number of true positives + \\ the total number of false negatives\end{matrix}}{total number of initial consumers} ;$$

a precision of the targeting model, where:

$$precision = \frac{the total number of true positives}{\begin{matrix}the total number of true positives + \\ the total number of false positives\end{matrix}} ;$$

a lift of the targeting model, where:

$$lift = \frac{the precision}{the natural incidence} ;$$

a suppression of the targeting model, where:

$$suppresion = \frac{the total number of true negatives}{\begin{matrix}the total number of true negatives + \\ the total number of false positives\end{matrix}} ;$$

and/or

a misclassification rate of the targeting model, where:

$$misclassification rate = \frac{\begin{matrix}the total number of false positives + \\ the total number of false negatives\end{matrix}}{the total number of initial consumers} ;$$

Additionally, steps 1201-1203 can be repeated for multiple different values of the score threshold. For example, the score threshold can be recalculated for multiple values of ν, such as 0, 0.5, 1, 1.5, etc., The confusion matrix can then be re-generated for each value of ν and one or more above the above-mentioned metrics can be re-calculated based on the values in each re-generated confusion matrix. As the value of ν increases the precision will also increase with diminishing returns. A good model will have a high lift and a statistically significant number of consumers which have corresponding target variable that indicates that the consumer meets the target profile.

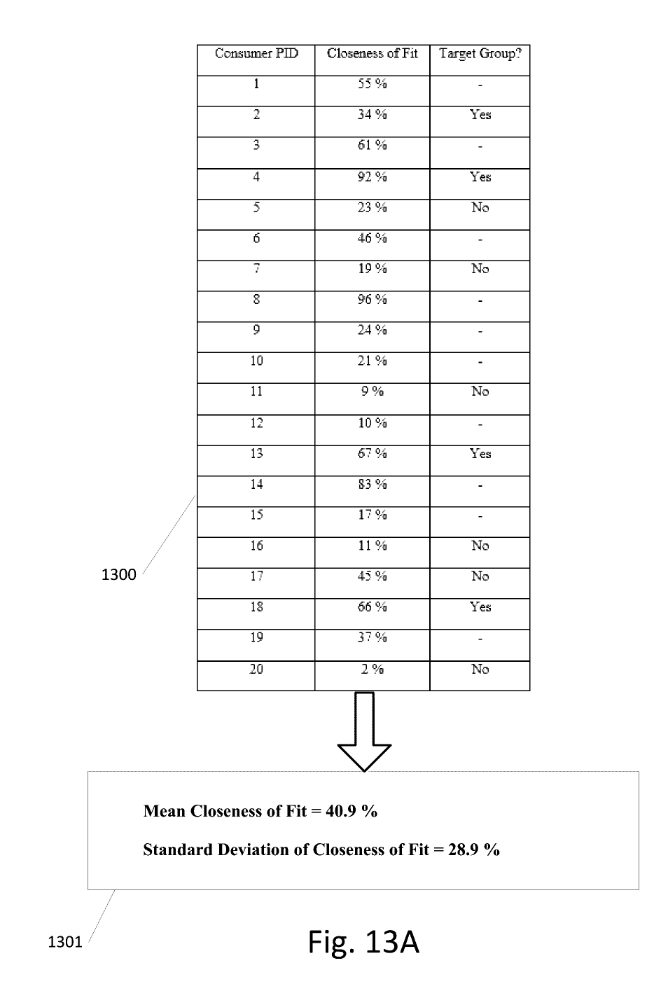

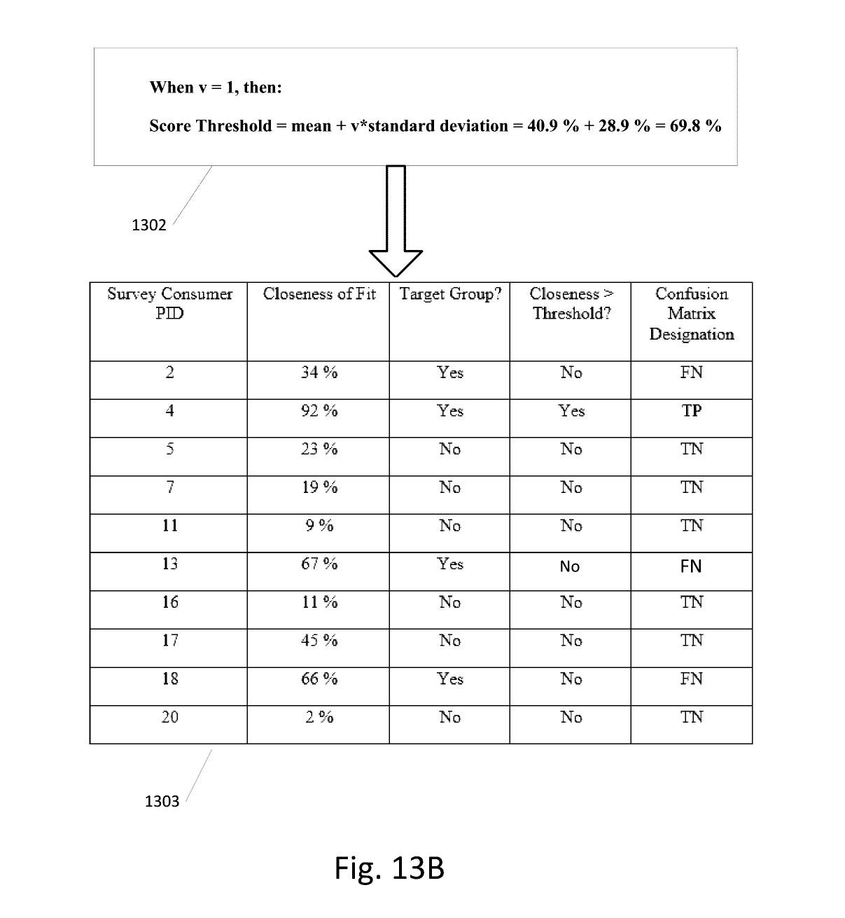

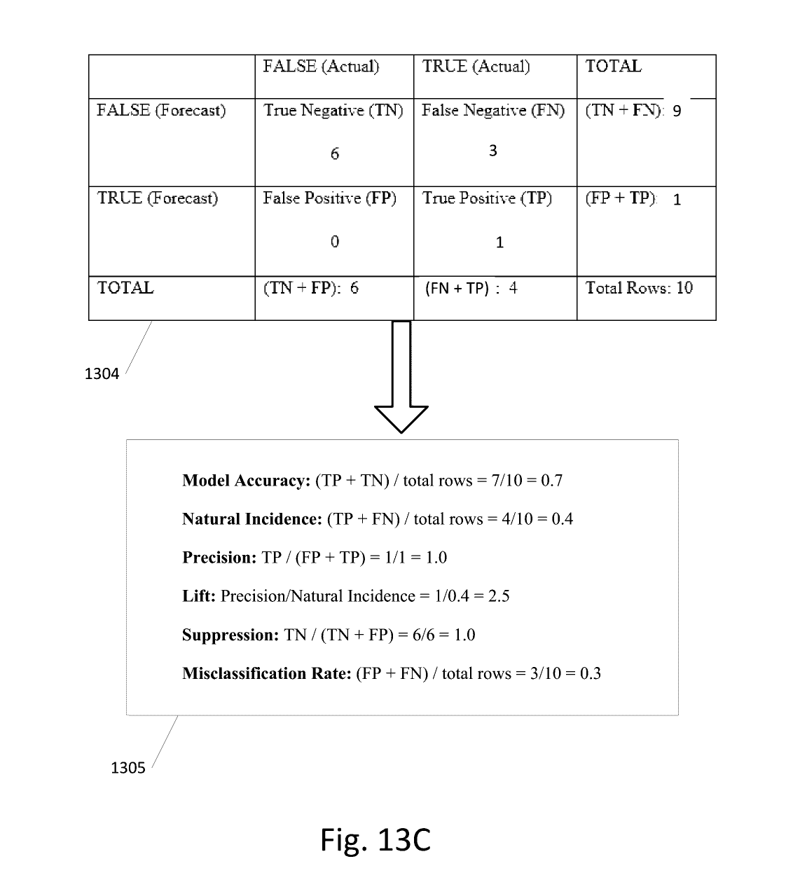

FIGS. 13A-13C illustrate an example of the method described in FIG. 12. Table 1300 of FIG. 13A illustrates the experimental scores (closeness of fit) of consumers in the experimental group of consumers. The initial group of consumers within the experimental group of consumers can be identified as the consumers which have a corresponding target variable (target group? in table 1300).

As shown in box 1301, the mean experimental score (mean closeness of fit) value of the scores in table 1300 is 40.9% and the standard deviation is 28.9%. Box 1302 in FIG. 13B illustrates the corresponding score threshold when ν=1, which is 69.8%. Table 1303 is similar to table 1300 but includes only the experimental scores corresponding the initial group of consumers. Table 1303 also includes additional two columns. The first additional column indicates whether the experimental score is greater than the threshold score (Closeness>Threshold?) and the second additional column indicates a confusion matrix designation for a corresponding consumer based on whether the consumer is in the target group and whether the experimental score for that consumer is greater than the score.

FIG. 13C illustrates the confusion matrix 1304 generated from table 1303 in FIG. 13B. The confusion matrix classifies each consumer using the following classifications:

True (Actual)—the consumer has a corresponding target variable which indicates that the consumer meets the target profile,

False (Actual)—the consumer has a corresponding target variable which indicates that the consumer does not meet the target profile,

True (Forecast)—the consumer has an experimental score above the score threshold, and

False (Forecast)—the consumer has an experimental score at or below the score threshold.

Box 1305 illustrates metrics regarding the effectiveness of the targeting model for ν=1 based on the confusion matrix 1304. These include model accuracy, natural incidence, precision, lift, suppression, and misclassification rate.

While the techniques described herein are described with respect to targeting models, the techniques can be utilized to determine the effectiveness of models outside of targeting models. For example, the method, apparatus, and computer-readable media disclosed herein can be used to determine effectiveness of any computer model which is configured to select, identify, or rank a set of entities (consumers, records, objects, data, users, sources, websites, products, advertisements, etc.) in a data set.

In this case, the plurality of target variables corresponding to an initial group of consumers can be replaced with a plurality of variables corresponding to an initial group of entities, with each variable indicating whether a corresponding entity in the initial group of entities meets one or more conditions. Information on whether the entities in the initial group meet the one or more conditions can be collected by any means, including data mining, scraping of websites or social media, surveys, etc. Additionally, the initial group of entities can be part of an experimental group of entities which is larger than the initial group of entities. The method can include setting the plurality of variables corresponding to the initial group of entities to indicate whether each of the entities meets the one or more conditions.

The method can also include applying the computer model to an experimental set of data corresponding to the experimental group of entities to generate a plurality of experimental scores which score the experimental group of entities according to projected fit with the one or more conditions.

The method can further include identifying any experimental scores in the plurality of experimental scores which correspond to the initial group of entities and determining an effectiveness of the computer model with respect to the one or more conditions based at least in part on the plurality of variables and one or more metrics which quantify the identified experimental scores corresponding to the initial group of entities relative to the plurality of experimental scores corresponding to the experimental group of entities. Any of the techniques described herein (applying the computer model to an initial data set corresponding to the initial group of entities, generating initial ranks and rank groups, generating experimental ranks and rank groups, calculating lift and/or drift, generating a score threshold and confusion matrix, calculating effectiveness metrics based on the confusion matrix) can then be applied to the results of the computer model to determine the effectiveness of the computer model.

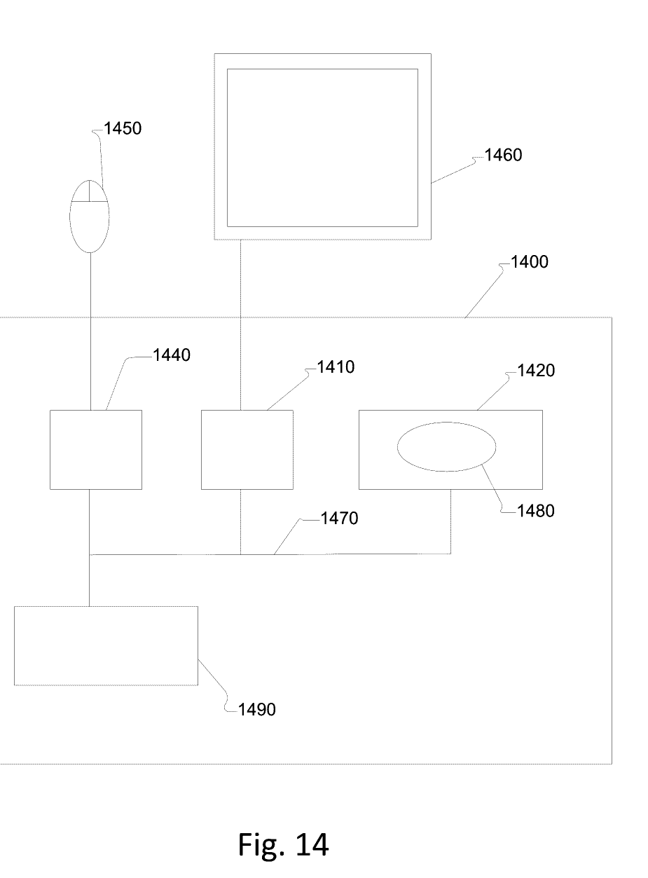

One or more of the above-described techniques can be implemented in or involve one or more computer systems. FIG. 14 illustrates a generalized example of a computing environment 1400. The computing environment 1400 is not intended to suggest any limitation as to scope of use or functionality of a described embodiment.

The computing environment 1400 includes at least one processing unit 1410 and memory 1420. The processing unit 1410 executes computer-executable instructions and can be a real or a virtual processor. In a multi-processing system, multiple processing units execute computer-executable instructions to increase processing power. The memory 1420 can be volatile memory (e.g., registers, cache, RAM), non-volatile memory (e.g., ROM, EEPROM, flash memory, etc.), or some combination of the two. The memory 1420 can store software 1480 implementing described techniques.

A computing environment can have additional features. For example, the computing environment 1400 includes storage 1440, one or more input devices 1450, one or more output devices 1460, and one or more communication connections 1490. An interconnection mechanism 1470, such as a bus, controller, or network interconnects the components of the computing environment 1400. Typically, operating system software or firmware (not shown) provides an operating environment for other software executing in the computing environment 1400, and coordinates activities of the components of the computing environment 1400.

The storage 1440 can be removable or non-removable, and includes magnetic disks, magnetic tapes or cassettes, CD-ROMs, CD-RWs, DVDs, or any other medium which can be used to store information and which can be accessed within the computing environment 1400. The storage 1440 can store instructions for the software 1480.

The input device(s) 1450 can be a touch input device such as a keyboard, mouse, pen, trackball, touch screen, or game controller, a voice input device, a scanning device, a digital camera, remote control, or another device that provides input to the computing environment 1400. The output device(s) 1460 can be a display, television, monitor, printer, speaker, or another device that provides output from the computing environment 1400.

The communication connection(s) 1490 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 1400, computer-readable media include memory 1420, storage 1440, communication media, and combinations of any of the above.

Of course, FIG. 14 illustrates computing environment 1400, display device 1460, and input device 1450 as separate devices for ease of identification only. Computing environment 1400, display device 1460, and input device 1450 can be separate devices (e.g., a personal computer connected by wires to a monitor and mouse), can be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing environment 1400 can be a set-top box, personal computer, or one or more servers, for example a farm of networked servers, a clustered server environment, or a cloud network of computing devices.

Having described and illustrated the principles of our invention with reference to the described embodiment, it will be recognized that the described embodiment can be modified in arrangement and detail without departing from such principles. It should be understood that the programs, processes, or methods described herein are not related or limited to any particular type of computing environment, unless indicated otherwise. Various types of general purpose or specialized computing environments can be used with or perform operations in accordance with the teachings described herein. Elements of the described embodiment shown in software can be implemented in hardware and vice versa.

In view of the many possible embodiments to which the principles of our invention can be applied, we claim as our invention all such embodiments as can come within the scope and spirit of the following claims and equivalents thereto

What is claimed is:

1. A method executed by one or more computing devices for determining effectiveness of a targeting model, the method comprising:
setting, by at least one of the one or more computing devices, a plurality of target variables corresponding to an initial group of consumers, wherein each target variable in the plurality of target variables indicates whether a corresponding consumer in the initial group of consumers meets a target profile and wherein the initial group of consumers corresponds to a subgroup of an experimental group of consumers which is larger than the initial group of consumers;
applying, by at least one of the one or more computing devices, the targeting model to an experimental set of consumer data corresponding to the experimental group of consumers to generate a plurality of experimental scores which score the experimental group of consumers according to projected fit with the target profile;
identifying, by at least one of the one or more computing devices, any experimental scores in the plurality of experimental scores which correspond to the initial group of consumers; and
determining, by at least one of the one or more computing devices, an effectiveness of the targeting model with respect to the target profile based at least in part on the plurality of target variables and one or more metrics which quantify the identified experimental scores corresponding to the initial group of consumers relative to the plurality of experimental scores corresponding to the experimental group of consumers.

2. The method of claim 1, wherein setting a plurality of target variables corresponding to an initial group of consumers comprises, for each consumer in the initial group of consumers:
receiving one or more answers to one or more survey questions;
comparing the one or more answers to one or more target answers specified in the target profile to a determine a matching percentage; and
setting a target variable corresponding to that consumer to true based at least in part on a determination that the matching percentage is above a predetermined threshold.

3. The method of claim 1, further comprising:
applying, by at least one of the one or more computing devices, the targeting model to an initial set of consumer data corresponding to the initial group of consumers to generate a plurality of initial scores which score the initial group of consumers according to projected fit with the target profile; and
assigning, by at least one of the one or more computing devices, each consumer in the initial group of consumers to an initial rank group in a plurality of initial rank groups based at least in part on an initial score for that consumer relative to the plurality of initial scores.

4. The method of claim 3, wherein determining an effectiveness of the targeting model with respect to the target profile based at least in part on the plurality of target variables and one or more metrics which quantify the identified experimental scores corresponding to the initial group of consumers relative to the plurality of experimental scores corresponding to the experimental group of consumers comprises:
assigning each consumer in the initial group of consumers to an experimental rank group in a plurality of experimental rank groups based at least in part on an identified experimental score for that consumer relative to the plurality of experimental scores, wherein a quantity of experimental rank groups is equal to a quantity of initial rank groups and wherein each experimental rank group in the plurality of experimental rank groups corresponds to an initial rank group in the plurality of initial rank groups;
determining an effectiveness of the targeting model with respect to the target profile based at least in part on the plurality of target variables, a set of initial rank groups assigned to the initial group of consumers, and a set of experimental rank groups assigned to the initial group of consumers.

5. The method of claim 4, wherein determining an effectiveness of the targeting model with respect to the target profile based at least in part on the plurality of target variables, a set of initial rank groups assigned to the initial group of consumers, and a set of experimental rank groups assigned to the initial group of consumers comprises:
generating one or more initial lift values corresponding to one or more initial rank groups in the set of initial rank groups by calculating an initial percentage of consumers in each initial rank group in the one or more initial rank groups which have a corresponding target variable that indicates that the consumer meets the target profile and dividing the initial percentage by a percentage of consumers in the initial group of consumers which have a corresponding target variable that indicates that the consumer meets the target profile;
generating one or more experimental lift values corresponding to one or more experimental rank groups in the set of experimental rank groups by calculating an experimental percentage of consumers in each experimental rank group in the one or more experimental rank groups which have a corresponding target variable that indicates that the consumer meets the target profile and dividing the experimental percentage by the percentage of consumers in the initial group of consumers which have a corresponding target variable that indicates that the consumer meets the target profile; and
comparing the one or more initial lift values with the one or more experimental lift values.

6. The method of claim 4, wherein determining an effectiveness of the targeting model with respect to the target profile based at least in part on the plurality of target variables, a set of initial rank groups assigned to the initial group of consumers, and a set of experimental rank groups assigned to the initial group of consumers comprises:
generating a plurality of drift values corresponding to the initial group of consumers by comparing, for each consumer in the initial group of consumers, an initial rank group assigned to that consumer and an experimental rank group assigned to that consumer;
grouping the initial group of consumers into a plurality of drift groups based at least in part on a drift value for each consumer in the initial group of consumers; and
determining a quantity of consumers in each drift group in the plurality of drift groups which have a corresponding target variable that indicates that the consumer meets the target profile based at least in part on the plurality of target variables.

7. The method of claim 1, wherein determining an effectiveness of the targeting model with respect to the target profile based at least in part on the plurality of target variables and one or more metrics which quantify the identified experimental scores corresponding to the initial group of consumers relative to the plurality of experimental scores corresponding to the experimental group of consumers comprises:
calculating a score threshold based at least in part on a mean value of the plurality of experimental scores;
generating a confusion matrix corresponding to the initial group of consumers based at least in part on the plurality of target variables, the score threshold, and the identified experimental scores corresponding to the initial group of consumers; and
determining an effectiveness of the targeting model with respect to the target profile based at least in part on the confusion matrix.

8. The method of claim 7, wherein:
the score threshold=μ+(ν*σ)
wherein μ comprises the mean value of the plurality of experimental scores;
wherein σ comprises a standard deviation of the plurality of experimental scores; and
wherein ν comprises a variable value greater than or equal to zero.

9. The method of claim 7, wherein generating a confusion matrix corresponding to the initial group of consumers based at least in part on the plurality of target variables, the score threshold, and the identified experimental scores corresponding to the initial group of consumers comprises:
assigning a designation of true positive to each consumer in the initial group of consumers having an identified experimental score above the score threshold and having a corresponding target variable that indicates that the consumer meets the target profile;
assigning a designation of false positive to each consumer in the initial group of consumers having an identified experimental score above the score threshold and having a corresponding target variable that indicates that the consumer does not meet the target profile;
assigning a designation of true negative to each consumer in the initial group of consumers having an identified experimental score below or equal to the score threshold and having a corresponding target variable that indicates that the consumer does not meet the target profile;
assigning a designation of false negative to each consumer in the initial group of consumers having an identified experimental score below or equal to the score threshold and having a corresponding target variable that indicates that the consumer meets the target profile; and
calculating a total number of true positives, a total number of false positives, a total number of true negatives, and a total number of false negatives.

10. The method of claim 9, wherein determining an effectiveness of the targeting model with respect to the target profile based at least in part on the confusion matrix comprises one or more of:
calculating an accuracy of the targeting model, wherein
$$accuracy = \frac{\begin{matrix}the total number of true positives + \\ the total number of true negatives\end{matrix}}{total number of initial consumers} ;$$
calculating a natural incidence of the targeting model, wherein
$$natural incidence = \frac{\begin{matrix}the total number of true positives + \\ the total number of false negatives\end{matrix}}{total number of initial consumers} ;$$
calculating a precision of the targeting model, wherein
$$precision = \frac{the total number of true positives}{\begin{matrix}the total number of true positives + \\ the total number of false positives\end{matrix}} ;$$
calculating a lift of the targeting model, wherein
$$lift = \frac{the precision}{the natural incidence} ;$$
calculating a suppression of the targeting model, wherein
$$suppression = \frac{the total number of true negatives}{\begin{matrix}the total number of true negatives + \\ the total number of false positives\end{matrix}} ;$$
or
calculating a misclassification rate of the targeting model, wherein
$$misclassification rate = \frac{\begin{matrix}the total number of false positives + \\ the total number of false negatives\end{matrix}}{the total number of initial consumers} .$$

11. An apparatus for determining effectiveness of a targeting model, the apparatus comprising:
one or more processors; and
one or more memories operatively coupled to at least one of the one or more processors and having instructions stored thereon that, when executed by at least one of the one or more processors, cause at least one of the one or more processors to:
set a plurality of target variables corresponding to an initial group of consumers, wherein each target variable in the plurality of target variables indicates whether a corresponding consumer in the initial group of consumers meets a target profile and wherein the initial group of consumers corresponds to a subgroup of an experimental group of consumers which is larger than the initial group of consumers;
apply the targeting model to an experimental set of consumer data corresponding to the experimental group of consumers to generate a plurality of experimental scores which score the experimental group of consumers according to projected fit with the target profile;
identify any experimental scores in the plurality of experimental scores which correspond to the initial group of consumers; and
determine an effectiveness of the targeting model with respect to the target profile based at least in part on the plurality of target variables and one or more metrics which quantify the identified experimental scores corresponding to the initial group of consumers relative to the plurality of experimental scores corresponding to the experimental group of consumers.

12. The apparatus of claim 11, wherein the instructions that, when executed by at least one of the one or more processors, cause at least one of the one or more processors to set a plurality of target variables corresponding to an initial group of consumers further cause at least one of the one or more processors to, for each consumer in the initial group of consumers:
receive one or more answers to one or more survey questions;
compare the one or more answers to one or more target answers specified in the target profile to a determine a matching percentage; and
set a target variable corresponding to that consumer to true based at least in part on a determination that the matching percentage is above a predetermined threshold.

13. The apparatus of claim 11, wherein at least one of the one or more memories has further instructions stored thereon that, when executed by at least one of the one or more processors, cause at least one of the one or more processors to:
apply the targeting model to an initial set of consumer data corresponding to the initial group of consumers to generate a plurality of initial scores which score the initial group of consumers according to projected fit with the target profile; and
assign each consumer in the initial group of consumers to an initial rank group in a plurality of initial rank groups based at least in part on an initial score for that consumer relative to the plurality of initial scores

14. The apparatus of claim 13, wherein the instructions that, when executed by at least one of the one or more processors, cause at least one of the one or more processors to determine an effectiveness of the targeting model with respect to the target profile based at least in part on the plurality of target variables and one or more metrics which quantify the identified experimental scores corresponding to the initial group of consumers relative to the plurality of experimental scores corresponding to the experimental group of consumers further cause at least one of the one or more processors to:
assign each consumer in the initial group of consumers to an experimental rank group in a plurality of experimental rank groups based at least in part on an identified experimental score for that consumer relative to the plurality of experimental scores, wherein a quantity of experimental rank groups is equal to a quantity of initial rank groups and wherein each experimental rank group in the plurality of experimental rank groups corresponds to an initial rank group in the plurality of initial rank groups;
determine an effectiveness of the targeting model with respect to the target profile based at least in part on the plurality of target variables, a set of initial rank groups assigned to the initial group of consumers, and a set of experimental rank groups assigned to the initial group of consumers.

15. The apparatus of claim 14, wherein the instructions that, when executed by at least one of the one or more processors, cause at least one of the one or more processors to determine an effectiveness of the targeting model with respect to the target profile based at least in part on the plurality of target variables, a set of initial rank groups assigned to the initial group of consumers, and a set of experimental rank groups assigned to the initial group of consumers further cause at least one of the one or more processors to:
generate a plurality of initial lift values corresponding to the set of initial rank groups by calculating an initial percentage of consumers in each initial rank group in the set of initial rank groups which have a corresponding target variable that indicates that the consumer meets the target profile and dividing the initial percentage by a percentage of consumers in the initial group of consumers which have a corresponding target variable that indicates that the consumer meets the target profile;
generate a plurality of experimental lift values corresponding to the set of experimental rank groups by calculating an experimental percentage of consumers in each experimental rank group in the set of experimental rank groups which have a corresponding target variable that indicates that the consumer meets the target profile and dividing the experimental percentage by the percentage of consumers in the initial group of consumers which have a corresponding target variable that indicates that the consumer meets the target profile; and
compare the plurality of initial lift values with the plurality of experimental lift values.

16. The apparatus of claim 14, wherein the instructions that, when executed by at least one of the one or more processors, cause at least one of the one or more processors to determine an effectiveness of the targeting model with respect to the target profile based at least in part on the plurality of target variables, a set of initial rank groups assigned to the initial group of consumers, and a set of experimental rank groups assigned to the initial group of consumers further cause at least one of the one or more processors to:
generate a plurality of drift values corresponding to the initial group of consumers by comparing, for each consumer in the initial group of consumers, an initial rank group assigned to that consumer and an experimental rank group assigned to that consumer;
group the initial group of consumers into a plurality of drift groups based at least in part on a drift value for each consumer in the initial group of consumers; and
determine a quantity of consumers in each drift group in the plurality of drift groups which have a corresponding target variable that indicates that the consumer meets the target profile based at least in part on the plurality of target variables.

17. The apparatus of claim 11, wherein the instructions that, when executed by at least one of the one or more processors, cause at least one of the one or more processors to determine an effectiveness of the targeting model with respect to the target profile based at least in part on the plurality of target variables and one or more metrics which quantify the identified experimental scores corresponding to the initial group of consumers relative to the plurality of experimental scores corresponding to the experimental group of consumers further cause at least one of the one or more processors to:
calculate a score threshold based at least in part on a mean value of the plurality of experimental scores;
generate a confusion matrix corresponding to the initial group of consumers based at least in part on the plurality of target variables, the score threshold, and the identified experimental scores corresponding to the initial group of consumers; and
determine an effectiveness of the targeting model with respect to the target profile based at least in part on the confusion matrix.

18. The apparatus of claim 17, wherein:
the score threshold=μ+(ν*σ)
wherein μ comprises the mean value of the plurality of experimental scores;
wherein σ comprises a standard deviation of the plurality of experimental scores; and
wherein ν comprises a variable value greater than or equal to zero.

19. The apparatus of claim 17, wherein the instructions that, when executed by at least one of the one or more processors, cause at least one of the one or more processors to generate a confusion matrix corresponding to the initial group of consumers based at least in part on the plurality of target variables, the score threshold, and the identified experimental scores corresponding to the initial group of consumers further cause at least one of the one or more processors to:
assign a designation of true positive to each consumer in the initial group of consumers having an identified experimental score above the score threshold and having a corresponding target variable that indicates that the consumer meets the target profile;
assign a designation of false positive to each consumer in the initial group of consumers having an identified experimental score above the score threshold and having a corresponding target variable that indicates that the consumer does not meet the target profile;
assign a designation of true negative to each consumer in the initial group of consumers having an identified experimental score below or equal to the score threshold and having a corresponding target variable that indicates that the consumer does not meet the target profile;
assign a designation of false negative to each consumer in the initial group of consumers having an identified experimental score below or equal to the score threshold and having a corresponding target variable that indicates that the consumer meets the target profile; and
calculate a total number of true positives, a total number of false positives, a total number of true negatives, and a total number of false negatives.

20. The apparatus of claim 19, wherein the instructions that, when executed by at least one of the one or more processors, cause at least one of the one or more processors to determine an effectiveness of the targeting model with respect to the target profile based at least in part on the confusion matrix further cause at least one of the one or more processors to perform one or more of:
calculating an accuracy of the targeting model, wherein
$$accuracy = \frac{\begin{matrix}the total number of true positives + \\ the total number of true negatives\end{matrix}}{total number of initial consumers} ;$$
calculating a natural incidence of the targeting model, wherein
$$natural incidence = \frac{\begin{matrix}the total number of true positives + \\ the total number of false negatives\end{matrix}}{total number of initial consumers} ;$$
calculating a precision of the targeting model, wherein
$$precision = \frac{the total number of true positives}{\begin{matrix}the total number of true positives + \\ the total number of false positives\end{matrix}} ;$$
calculating a lift of the targeting model, wherein
$$lift = \frac{the precision}{the natural incidence} ;$$
calculating a suppression of the targeting model, wherein
$$suppression = \frac{the total number of true negatives}{\begin{matrix}the total number of true negatives + \\ the total number of false positives\end{matrix}} ;$$
or
calculating a misclassification rate of the targeting model, wherein
$$misclassification rate = \frac{\begin{matrix}the total number of false positives + \\ the total number of false negatives\end{matrix}}{the total number of initial consumers} .$$

21. At least one non-transitory computer-readable medium storing computer-readable instructions that, when executed by one or more computing devices, cause at least one of the one or more computing devices to:
set a plurality of target variables corresponding to an initial group of consumers, wherein each target variable in the plurality of target variables indicates whether a corresponding consumer in the initial group of consumers meets a target profile and wherein the initial group of consumers corresponds to a subgroup of an experimental group of consumers which is larger than the initial group of consumers;
apply the targeting model to an experimental set of consumer data corresponding to the experimental group of consumers to generate a plurality of experimental scores which score the experimental group of consumers according to projected fit with the target profile;
identify any experimental scores in the plurality of experimental scores which correspond to the initial group of consumers; and
determine an effectiveness of the targeting model with respect to the target profile based at least in part on the plurality of target variables and one or more metrics which quantify the identified experimental scores corresponding to the initial group of consumers relative to the plurality of experimental scores corresponding to the experimental group of consumers.

22. The at least one non-transitory computer-readable medium of claim 21, wherein the instructions that, when executed by at least one of the one or more computing devices, cause at least one of the one or more computing devices to set a plurality of target variables corresponding to an initial group of consumers further cause at least one of the one or more computing devices to, for each consumer in the initial group of consumers:
receive one or more answers to one or more survey questions;
compare the one or more answers to one or more target answers specified in the target profile to a determine a matching percentage; and
set a target variable corresponding to that consumer to true based at least in part on a determination that the matching percentage is above a predetermined threshold.

23. The at least one non-transitory computer-readable medium of claim 21, further storing computer-readable instructions that, when executed by at least one of the one or more computing devices, cause at least one of the one or more computing devices to:
apply the targeting model to an initial set of consumer data corresponding to the initial group of consumers to generate a plurality of initial scores which score the initial group of consumers according to projected fit with the target profile; and
assign each consumer in the initial group of consumers to an initial rank group in a plurality of initial rank groups based at least in part on an initial score for that consumer relative to the plurality of initial scores

24. The at least one non-transitory computer-readable medium of claim 21, wherein the instructions that, when executed by at least one of the one or more computing devices, cause at least one of the one or more computing devices to determine an effectiveness of the targeting model with respect to the target profile based at least in part on the plurality of target variables and one or more metrics which quantify the identified experimental scores corresponding to the initial group of consumers relative to the plurality of experimental scores corresponding to the experimental group of consumers further cause at least one of the one or more computing devices to:
assign each consumer in the initial group of consumers to an experimental rank group in a plurality of experimental rank groups based at least in part on an identified experimental score for that consumer relative to the plurality of experimental scores, wherein a quantity of experimental rank groups is equal to a quantity of initial rank groups and wherein each experimental rank group in the plurality of experimental rank groups corresponds to an initial rank group in the plurality of initial rank groups;
determine an effectiveness of the targeting model with respect to the target profile based at least in part on the plurality of target variables, a set of initial rank groups assigned to the initial group of consumers, and a set of experimental rank groups assigned to the initial group of consumers.

25. The at least one non-transitory computer-readable medium of claim 21, wherein the instructions that, when executed by at least one of the one or more computing devices, cause at least one of the one or more computing devices to determine an effectiveness of the targeting model with respect to the target profile based at least in part on the plurality of target variables, a set of initial rank groups assigned to the initial group of consumers, and a set of experimental rank groups assigned to the initial group of consumers further cause at least one of the one or more computing devices to:
generate a plurality of initial lift values corresponding to the set of initial rank groups by calculating an initial percentage of consumers in each initial rank group in the set of initial rank groups which have a corresponding target variable that indicates that the consumer meets the target profile and dividing the initial percentage by a percentage of consumers in the initial group of consumers which have a corresponding target variable that indicates that the consumer meets the target profile;
generate a plurality of experimental lift values corresponding to the set of experimental rank groups by calculating an experimental percentage of consumers in each experimental rank group in the set of experimental rank groups which have a corresponding target variable that indicates that the consumer meets the target profile and dividing the experimental percentage by the percentage of consumers in the initial group of consumers which have a corresponding target variable that indicates that the consumer meets the target profile; and
compare the plurality of initial lift values with the plurality of experimental lift values.

26. The at least one non-transitory computer-readable medium of claim 21, wherein the instructions that, when executed by at least one of the one or more computing devices, cause at least one of the one or more computing devices to determine an effectiveness of the targeting model with respect to the target profile based at least in part on the plurality of target variables, a set of initial rank groups assigned to the initial group of consumers, and a set of experimental rank groups assigned to the initial group of consumers further cause at least one of the one or more computing devices to:
generate a plurality of drift values corresponding to the initial group of consumers by comparing, for each consumer in the initial group of consumers, an initial rank group assigned to that consumer and an experimental rank group assigned to that consumer;
group the initial group of consumers into a plurality of drift groups based at least in part on a drift value for each consumer in the initial group of consumers; and
determine a quantity of consumers in each drift group in the plurality of drift groups which have a corresponding target variable that indicates that the consumer meets the target profile based at least in part on the plurality of target variables.

27. The at least one non-transitory computer-readable medium of claim 21, wherein the instructions that, when executed by at least one of the one or more computing devices, cause at least one of the one or more computing devices to determine an effectiveness of the targeting model with respect to the target profile based at least in part on the plurality of target variables and one or more metrics which quantify the identified experimental scores corresponding to the initial group of consumers relative to the plurality of experimental scores corresponding to the experimental group of consumers further cause at least one of the one or more computing devices to:
calculate a score threshold based at least in part on a mean value of the plurality of experimental scores;
generate a confusion matrix corresponding to the initial group of consumers based at least in part on the plurality of target variables, the score threshold, and the identified experimental scores corresponding to the initial group of consumers; and
determine an effectiveness of the targeting model with respect to the target profile based at least in part on the confusion matrix.

28. The at least one non-transitory computer-readable medium of claim 21, wherein:
the score threshold=μ+(ν*σ)
wherein μ comprises the mean value of the plurality of experimental scores;
wherein σ comprises a standard deviation of the plurality of experimental scores; and
wherein ν comprises a variable value greater than or equal to zero.

29. The at least one non-transitory computer-readable medium of claim 21, wherein the instructions that, when executed by at least one of the one or more computing devices, cause at least one of the one or more computing devices to generate a confusion matrix corresponding to the initial group of consumers based at least in part on the plurality of target variables, the score threshold, and the identified experimental scores corresponding to the initial group of consumers further cause at least one of the one or more computing devices to:
assign a designation of true positive to each consumer in the initial group of consumers having an identified experimental score above the score threshold and having a corresponding target variable that indicates that the consumer meets the target profile;
assign a designation of false positive to each consumer in the initial group of consumers having an identified experimental score above the score threshold and having a corresponding target variable that indicates that the consumer does not meet the target profile;
assign a designation of true negative to each consumer in the initial group of consumers having an identified experimental score below or equal to the score threshold and having a corresponding target variable that indicates that the consumer does not meet the target profile;
assign a designation of false negative to each consumer in the initial group of consumers having an identified experimental score below or equal to the score threshold and having a corresponding target variable that indicates that the consumer meets the target profile; and
calculate a total number of true positives, a total number of false positives, a total number of true negatives, and a total number of false negatives.

30. The at least one non-transitory computer-readable medium of claim 21, wherein the instructions that, when executed by at least one of the one or more computing devices, cause at least one of the one or more computing devices to determine an effectiveness of the targeting model with respect to the target profile based at least in part on the confusion matrix further cause at least one of the one or more computing devices to perform one or more of:
calculating an accuracy of the targeting model, wherein
$$accuracy = \frac{\begin{matrix}the total number of true positives + \\ the total number of true negatives\end{matrix}}{total number of initial consumers} ;$$
calculating a natural incidence of the targeting model, wherein
$$natural incidence = \frac{\begin{matrix}the total number of true positives + \\ the total number of false negatives\end{matrix}}{total number of initial consumers} ;$$
calculating a precision of the targeting model, wherein
$$precision = \frac{the total number of true positives}{\begin{matrix}the total number of true positives + \\ the total number of false positives\end{matrix}} ;$$
calculating a lift of the targeting model, wherein
$$lift = \frac{the precision}{the natural incidence} ;$$
calculating a suppression of the targeting model, wherein
$$suppression = \frac{the total number of true negatives}{\begin{matrix}the total number of true negatives + \\ the total number of false positives\end{matrix}} ;$$
or
calculating a misclassification rate of the targeting model, wherein
$$misclassification rate = \frac{\begin{matrix}the total number of false positives + \\ the total number of false negatives\end{matrix}}{the total number of initial consumers} .$$
